(19) United States
(12) Patent Application Publication
(10) Pub. No.: US 2010/0005179 A1
(43) Pub. Date: Jan. 7, 2010

(54) Multi-Level Secure Network

(75) Inventors: Eric S. Dickson, McKinney, TX (US); Lynn W. Hitchcock, Clearwater, FL (US); Michael J. Femal, St. Petersburg, FL (US); James M. Jolly, Mabank, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/496,444

(22) Filed: Jul. 1, 2009

Related U.S. Application Data
(60) Provisional application No. 61/078,220, filed on Jul. 3, 2008.

(51) Int. Cl. G06F 15/173

(52) U.S. Cl. 709/228

(57) ABSTRACT

In certain embodiments, a method for establishing a communication session includes receiving, from a first endpoint, a request to establish a communication session with a second endpoint. The first endpoint has an associated first security level and is operable to communicate via an IP network, the second endpoint has an associated second security level, and the first security level and the second security level are different. The method further includes determining, based on the first security level associated with the first endpoint and the second security level associated with the second endpoint, a communication session security level. The method further includes determining a communication session path for the requested communication session, the communication session path comprising a media processing module corresponding to the determined communication session security level. The method further includes establishing the requested communication session with the second endpoint over the determined communication session path.

### RELATED APPLICATIONS

This application claims the benefit under 35 U.S.C. section 119(e) of the priority of U.S. Provisional Application No. 61/078,220, filed Jul. 3, 2008, entitled “Multi-Level Secure Network.”

### TECHNICAL FIELD

This invention relates generally to communications networks and more particularly to a multi-level secure network.

### BACKGROUND

In the field of telecommunications, there are a number of different communications networks that facilitate the communication of media (e.g., voice, data, video) between endpoints. For example, information may be communicated between a source and destination using a circuit-based network having a communication channel linking the source and destination. To transfer multiple media streams over a single communication channel, time division multiplexing (TDM) may be used. In a TDM-based system, two or more media streams (e.g., bit streams) may be transferred apparently simultaneously over one communication channel by dividing the communication channel into a number of recurring timeslots (sub-channels). Each media stream may then be broken into a plurality of TDM frames and passed over the communication channel, each TDM frame corresponding to a particular timeslot (sub-channel). The plurality of frames may then be reassembled at the receiving end based on the timing.

As another example, information may be communicated between endpoints in a packet-based network. In a packet-based network, there are no direct links between source and destination like in circuit-based networks. Rather, media streams are broken up into blocks (packets) and transferred over a shared network that routes each packet independently from all others and allocates transmission resources as needed. An example protocol for transferring packets over a packet based network is the Internet Protocol (IP), which delivers packets from source to destination based solely on the address of the packets.

### SUMMARY

According to the present invention, disadvantages and problems associated with previous techniques for providing a secure network may be reduced or eliminated.

In certain embodiments, a method for establishing a communication session includes receiving, from a first endpoint, a request to establish a communication session with a second endpoint. The first endpoint has an associated first security level and is operable to communicate via an IP network, the second endpoint has an associated second security level, and the first security level and the second security level are different. The method further includes determining, based on the first security level associated with the first endpoint and the second security level associated with the second endpoint, a communication session security level. The method further includes determining a communication session path for the requested communication session, the communication session path comprising a media processing module corresponding to the determined communication session security level. The method further includes establishing the requested communication session with the second endpoint over the determined communication session path.

Particular embodiments of the present invention may provide one or more technical advantages. In certain applications, particular organizations may utilize multi-level secure (MLS) communication systems that are capable of facilitating multiple, simultaneous communications sessions for exchanging media having differing sensitivities (i.e., security levels) while maintaining a certain degree of security with respect to the exchanged media. The degree of security maintained with respect to the exchanged media may vary depending on the particular implementation of the MLS communication system. For example, the United States government may utilize a MLS communication system for exchanging media classified as SECRET, TOP-SECRET (TS), or TOP-SECRET/SENSITIVE COMPARTMENTED INFORMATION (TS/SCI). Furthermore, the Director of Central Intelligence Directive (DCID) 6/3 specification states that an MLS communication system that processes TS or TS/SCI must separate media of differing security levels either through encryption or physical separation in order to limit access to media to only those users having appropriate security authorizations.

One approach to providing an MLS communication system includes a circuit-based, time-division multiplexed (TDM) architecture. A circuit-based TDM architecture may meet the requirements of the DCID 6/3 specification by performing “separation in time.” In separation in time, all circuits are time-sliced, synchronized, and constantly monitored such that media of differing security levels is physically separated at all points within the architecture. Communication systems, however, are increasingly being implemented using packet-based architectures (e.g., Internet Protocol (IP) architectures) rather than circuit-based architectures (e.g., TDM architectures). Furthermore, mechanisms used to maintain security in the TDM domain (e.g., separation in time) cannot be applied in the IP domain. Thus, a need exists for a MLS communication network operable to facilitate communication sessions in the IP domain while maintaining a degree of security with respect to exchanged media, such as the degree of security required by the DCID 6/3 specification.

In certain embodiments, the MLS communication system of the present invention facilitates communication sessions in the IP domain (e.g., by facilitating communication sessions between endpoints via an IP network) as well as in the mixed domain (e.g., communications sessions between an endpoint located in the IP domain and an endpoint in the TDM domain). Additionally, the MLS communication system of the present invention may maintain security with respect to media exchanged in the facilitated communication sessions by ensuring that the media exchanged is either encrypted or physically separated from media of differing security levels at all points within the system. Thus, certain embodiments of the present invention may increase communication capabilities, such as in applications requiring multi-level security (e.g., applications required to meet the requirements of the DCID 6/3 specification).

Certain embodiments of the present invention may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIGS. 1A-1B illustrate an example multi-level secure communication system, according to certain embodiments of the present invention;

FIGS. 3A-3B illustrate example hardware configurations of a cross-connect element of an adjudicator in an example multi-level secure communication system, according to certain embodiments of the present invention;

FIGS. 4A-4B illustrate a conference call situation and associated example call flow resulting in a change in communication session security level in an example multi-level secure communication system, according to certain embodiments of the present invention;

FIGS. 5A-5B illustrate example call flows for securely handling a call hold operation in an example multi-level secure communication system, according to certain embodiments of the present invention; and

FIGS. 6A-6B illustrate example call flows for securely handling a call transfer operation in an example multi-level secure communication system, according to certain embodiments of the present invention.

### DESCRIPTION OF EXAMPLE EMBODIMENTS

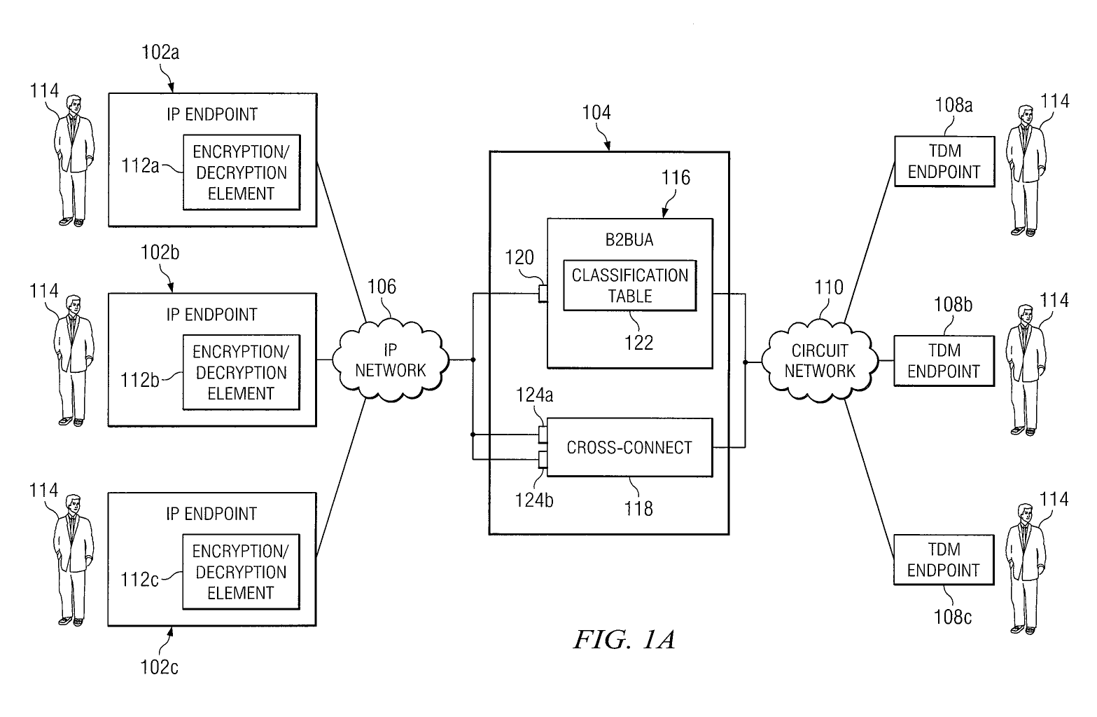

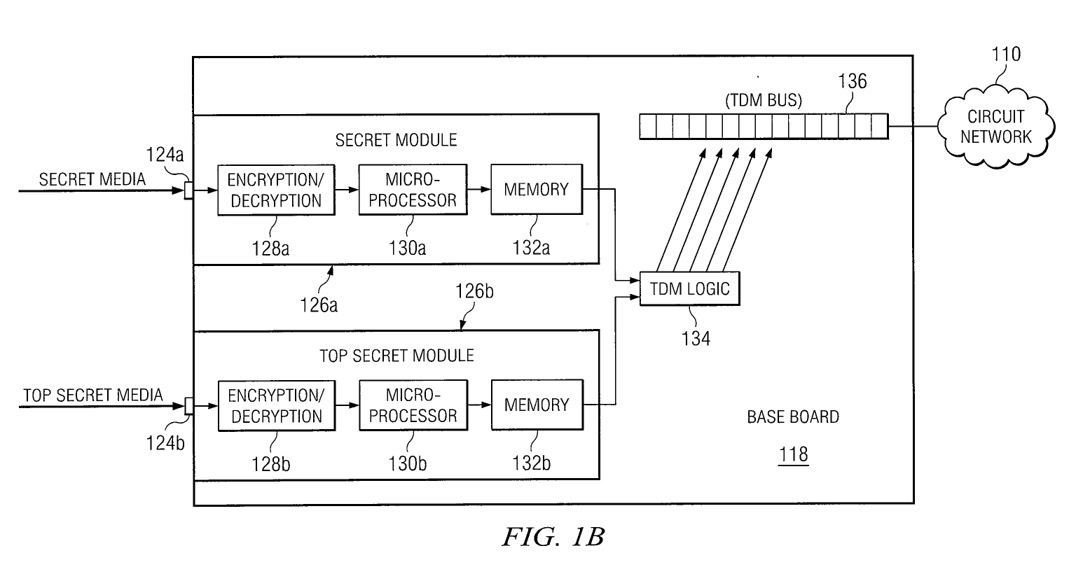

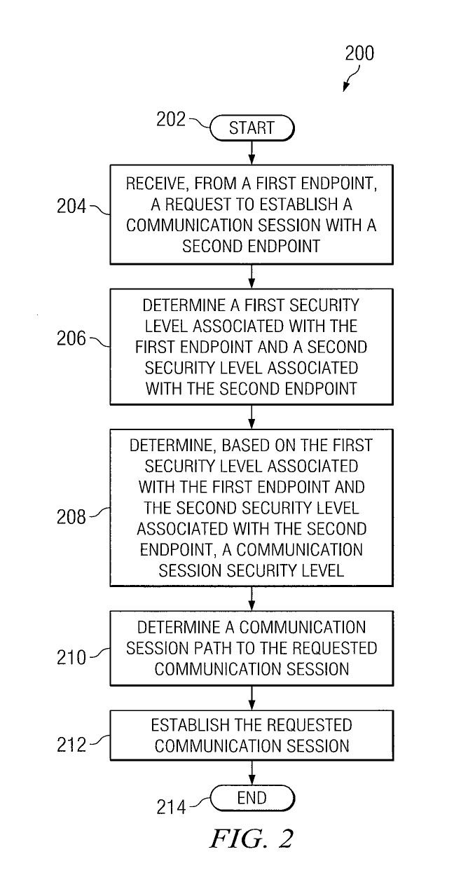

FIG. 1 illustrates an example multi-level secure (MLS) communication system 100, according to certain embodiments of the present invention. System 100 may include a plurality of IP endpoints 102 and one or more adjudicators 104, the plurality of IP endpoints 102 configured to communicate with the one or more adjudicators 104 via IP network 106. System 100 may also include a plurality of TDM endpoints 108, the plurality of TDM endpoints configured to communicate with the one or more adjudicators 104 via a circuit network 110. Although this particular implementation of system 100 is illustrated and primarily described, the present invention contemplates any suitable implementation of system 100 according to particular needs.

In general, system 100 is operable to facilitate a communication session between a first endpoint (e.g., IP endpoint 102 or TDM endpoint 108) and a second endpoint (e.g., IP endpoint 102 or TDM endpoint 108) such that the first and second endpoints may exchange media. “Media” may include voice, data, video, or any other suitable type of information. The communications session may have an associated communication session security level determined by adjudicator 104 based on a first security level associated with the first endpoint and a second security level associated with the second endpoint, the communication session security level corresponding to the sensitivity of the media that may be exchanged between the first and second endpoints during the communication session. Furthermore, system 100 is operable to maintain security with respect to the media exchanged during the communication session once established by ensuring that the media is either encrypted or physically separated from media being exchanged in communication sessions having differing communication session security levels at all points along the communication path linking the first and second endpoints.

As a result, system 100 may facilitate communication sessions in the IP domain (e.g., communications sessions between IP endpoints 102) as well as in the mixed domain (e.g., communications sessions IP endpoints 102 and TDM endpoints 108) while maintaining security with respect to the media exchanged in the facilitated communication sessions. Thus, system 100 may provide for increased communication capabilities in applications requiring multi-level security, such as applications required to meet the requirements of the DCID 6/3 specification.

The one or more IP endpoints 102 of system 100 may include any appropriate input devices, output devices, mass storage media, processors, memory, or other suitable components for receiving, processing, storing, and communicating media with adjudicator 104 via IP network 106. For example, IP endpoints 102 may include a personal computer, workstation, network computer, kiosk, wireless data port, personal data assistant (PDA), one or more Internet Protocol (IP) telephones, one or more processors within these or other devices, or any other suitable device. As a particular example, IP endpoints 102 may be multiple line voice-over-IP (VOIP) telephones.

IP endpoints 102 may each include an endpoint encryption/decryption element 112. An encryption/decryption element 112 of an IP endpoint 102 may encrypt media communicated by an IP endpoint 102 via IP network 106 (e.g., to adjudicator 104 or another IP endpoint 102, as described below). Encryption/decryption element 112 may encrypt media communicated by an IP endpoint 102 using any suitable encryption standard, according to particular needs. For example, the encryption applied to media by encryption/decryption application 112 of an IP endpoint 102 may be a Type I encryption (e.g., an Advanced Encryption Standard (AES) encryption) mandated by the National Security Agency (NSA) for use with SECRET and TOP-SECRET communication session security levels. Additionally, an encryption/decryption application 112 of an IP endpoint 102 may decrypt media received via IP network 106 (e.g., from adjudicator 104 or another IP endpoint 102, as described below).

IP endpoints 102 may be communicatively coupled to one another as well as to adjudicator 104 via IP network 106. Although referred to as an “IP network,” IP network 106 may include any network that facilitates wireless or wireline communication and communicates, for example, IP packets, Frame Relay frames, Asynchronous Transfer Mode (ATM) cells, voice, video, data, and other suitable information between network addresses. For example, IP network 106 may include one or more local area networks (LANs), radio access networks (RANs), metropolitan area networks (MANs), wide area networks (WANs), all or a portion of the global computer network known as the Internet, and/or any other communication system or systems at one or more locations.

The one or more TDM endpoints 108 of system 100 may include any appropriate input devices, output devices, mass storage media, processors, memory, or other suitable components for receiving, processing, storing, and communicating media with adjudicator 104 via circuit network 110. For example, TDM endpoint 108 may include a telephone or any other suitable TDM-compatible device.

TDM endpoints 108 may be communicatively coupled to one another as well as to adjudicator 104 via circuit network 110. Circuit network 110 may include any suitable combination of directly connected (wired) digital synchronous or analog terminals and intervening equipment for switching or conferencing any such digital synchronous or analog terminals.

IP endpoints 102 and TDM endpoints 108 may each have one or more associated users 114. Users 114 may each belong to one or more security clearance groups defined in system 100. The one or more security clearance groups to which a particular user 114 belongs may correspond to the sensitivity of media that the user is authorized to receive, view, and/or access. In certain embodiments, the plurality of clearance groups of system 100 may be arranged in a vertical hierarchy such that a user belonging to one clearance group necessarily belongs to all lesser clearance groups.

For example, the plurality of security clearance groups defined in system 100 may include a SECRET clearance group, a TOP-SECRET clearance group, and a TOP-SECRET SENSITIVE COMPARTMENTED INFORMATION (TS/SCI) clearance group. Furthermore, the groups may be arranged in a vertical hierarchy in such that a user 114 belonging to TOP-SECRET clearance group would also, by default, belong to all lesser groups (i.e., the SECRET clearance group). Thus, a user belonging to the TOP-SECRET clearance group would be authorized to receive, view and/or access media designated as SECRET or TOP-SECRET. Although users 114 of system 100 are primarily described throughout the remainder of this description as belonging to one or more particular clearance groups (i.e., SECRET, TOP-SECRET, and TS/SCI), the present invention contemplates users 114 of system 100 belonging to one or more of any suitable number of any suitable clearance groups, according to particular needs.

IP endpoints 102 and TDM endpoints 108 may each have one or more associated security levels. The one or more security levels associated with a particular endpoint (either an IP endpoint 102 or a TDM endpoint 108) may correspond to the sensitivity of media that may be exchanged in a communication session involving the particular endpoint, as described below. In certain embodiments, the security level associated with a particular endpoint may correspond to the group memberships of the one or more users 114 associated with the endpoint. For example, in the above described example in which users 114 belong to SECRET, TOP-SECRET, and/or TS/SCI clearance groups, IP endpoints 102 and TDM endpoints 108 may each have one or more associated security levels of SECRET, TOP-SECRET, and/or TS/SCI.

In certain embodiments, a particular endpoint (either an IP endpoint 102 or a TDM endpoint 108) may have more than one associated security level. For example, a user 114 of the particular endpoint may belong to the TOP-SECRET clearance group (as well as the SECRET clearance group by default, as described above), and the particular endpoint may have an associated security levels corresponding to each clearance group membership of the user 114 (e.g., a SECRET security level and a TOP-SECRET security level). As a particular example, IP endpoint 102a may have an associated user belonging to the TOP-SECRET clearance group (as well as the SECRET clearance group by default, as described above), and IP endpoint 102a may be a multiple line VOIP telephone having a first line (SECRET security level) and a second line (TOP-SECRET security level).

Adjudicator 104 of system 100 may facilitate communication sessions between endpoints (i.e., IP endpoints 102 and/or TDM endpoints 108) in system 100. For example, adjudicator 104 may facilitate a communication session between a first endpoint (e.g., IP endpoint 102 or TDM endpoint 108) and a second endpoint (e.g., IP endpoint 102 or TDM endpoint 108) such that the first and second endpoints may exchange media. Additionally, adjudicator 104 may maintain security with respect to the media exchanged during the communication session once established, as described in further detail below.

Adjudicator 104 may include a back-to-back user agent (B2BUA) 116 and a cross-connect 118. Although certain functionality is described below as being performed by either B2BUA 116 or cross-connect 118, the present invention contemplates the functionality being performed by B2BUA 116, cross-connect 118, or any suitable combination of B2BUA 116 and cross-connect 118, according to particular needs. Furthermore, although B2BUA 116 is illustrated and primarily described as being a B2BUA, the present invention contemplates the functionality described below as being performed by B2BUA 116 being performed by a proxy or any other suitable component.

B2BUA 116 may receive from a first endpoint (either an IP endpoint 102 or a TDM endpoint 108) a request to establish a communication session with a second endpoint (either an IP endpoint 102 or a TDM endpoint 108). For example, B2BUA 116 may receive a request to establish a communication session from IP endpoint 102a via control port 120. In certain embodiments, IP endpoints 102a may communicate with B2BUA 116 using one or more session control protocols, such as Session Initiation Protocol (SIP), H.323 protocol, CISCO Skinny Call Control Protocol (SCCP), or any other suitable session control protocol. As a particular example, IP endpoints 102 may communicate with B2BUA 116 using secure SIP (SIPS) using transport layer security (TLS) according to Request for Comments (RFC) 3261 or 4346.

B2BUA 116 may determine, based on the received request, a first security level associated with the first endpoint and a second security level associated with the second endpoint. In certain embodiments, B2BUA 116 may determine a first security level associated with the first endpoint and/or a second security level associated with the second endpoint by accessing security level table 122. Security level table 122 may include a one to one mapping of unique addresses associated with endpoints (or lines of endpoint in the endpoint has multiple lines, such as a multiple line VOIP telephone) to the security level associated with the endpoints. In other words, based on the unique addresses associated with the first and second endpoint (or the unique address of a particular line of the first or second endpoint if the either includes multiple lines) from the received request, B2BUA 116 may determine the first security level associated with the first endpoint and the second security level associated with the second endpoint based on security level table 122.

Certain received requests, however, may not specify a unique address associated with the second endpoint. Thus, B2BUA 116 may not be able to determine the unique address associated with the second endpoint based on the received request alone. For example, the second endpoint may be a multiple line VOIP telephone (e.g., IP endpoint 102a) and the received request may only include a telephone number associated with the VOIP telephone (rather than a unique address of a particular line of the VOIP phone). Because each line of the VOIP telephone may have a different security level (e.g., different users 114 belonging to a different security clearance group may be associated with each line of the VOIP telephone), the security level associated with the second endpoint for purposes of the requested communication session may be dependent upon which line of the VOIP telephone is used in the communication session (e.g., which user 114 answers the telephone).

Because B2BUA 116 may not be able to determine the unique address associated with the second endpoint based on the received request alone, B2BUA 116 may communicate an initial communication session request to the second endpoint. Based on the user 114 associated with second endpoint that responds to the initial communication session request, B2BUA 116 may determine the unique address associated with the second endpoint for purposes of the requested communication session. Based on the determined unique address of the second endpoint and security table 122, B2BUA 116 may determine the security level associated with the second endpoint. For example, in the above described example in which the second endpoint is a multiple line VOIP telephone (e.g., IP endpoint 102a), and the received communication request include only a telephone number associated with the VOIP phone, B2BUA 116 may ring the telephone number of the VOIP telephone such that all lines of the phone ring. Based on which line of the VOIP telephone answers, B2BUA 116 may determine the unique address associated with the VOIP telephone for purposes of the requested communication session. Based on the determined unique address of the VOIP telephone and security table 122, B2BUA 116 may determine the security level associated with the VOIP telephone.

In certain embodiments, a first security level associated with the first endpoint and/or a second security level associated with the second endpoint may be communicated to B2BUA 116 along with the request to establish a communication session such that B2BUA 116 need not determine the first security level and/or the second security level based on the unique address of the first and/or second endpoints, as described above. In response to the received first and/or second security levels, B2BUA 116 may determine that the endpoint designating the security levels (i.e., the first endpoint) is authorized to designate security levels. In response to a determination that the first endpoint is authorized, B2BUA 116 may determine a communication session security level based on the communicated first and/or second security level, as described below.

For example, the first endpoint may be an IP endpoint 102a that does not have a corresponding unique address in security level table 122, and IP endpoint 102a may communicate it's associated first security level (e.g., TOP-SECRET) to B2BUA 116 along with the request to establish a communication session. In response to the received request, B2BUA 116 may determine whether IP endpoint 102a is authorized to designate security levels. In response to a determination that the IP endpoint 102a is authorized, B2BUA 116 may determine a communication session security level based on the communicated first security level (TOP-SECRET), as described below.

Having determined a first security level associated with the first endpoint and a second security level associated with the second endpoint, B2BUA 116 may determine a communication session security level associated with a requested communication session. The determined communication session security level may be selected from a group of communication session security levels having corresponding media processing modules 126 in cross-connect 118. As a particular example, cross connect 118 may include a SECRET media processing module 126a and a TOP-SECRET media processing module 126b. Thus, B2BUA 116 may determine either a communication session security level of SECRET or a communication session security level of TOP-SECRET.

In certain embodiments, B2BUA 116 may determine the communication session security level by determining a combined security level based on the first security level associated with the first endpoint and the second security level associated with the second endpoint and associating the combined security level with a communication session security level. The possible combined security levels may include any security level that may be associated with an endpoint (e.g., SECRET, TOP-SECRET, or TS/SCI in the example described above) and may correspond to the highest possible security level at which both endpoints are authorized to communicate. For example, if the first endpoint and the second endpoint have the same associated security level, the combined security level may be the same as the first and second security levels. Alternatively, if the first endpoint and the second endpoint have different associated security levels, B2BUA 116 may determine the highest possible security level at which both endpoints may communicate. In certain embodiment, B2BUA 116 may include an algorithm to facilitate the above-described determination of the combined security level.

As a particular example, if both the first and second security levels are SECRET, B2BUA 116 may determine a combined security level of SECRET. As another particular example, if the first security level associated with the first endpoint is SECRET and the second security level associated with the second endpoint is TOP-SECRET, B2BUA 116 may determine a combined security level of SECRET. As yet another additional particular example, the if the first security level associated with the first endpoint is TOP-SECRET and the second security level associated with the second endpoint is TS/SCI, B2BUA 116 may determine a combined security level of TOP-SECRET.

Having determined a combined security level, B2BUA 116 may associate the combined security level with a communication session security level. Each possible combined security level may be associated with a particular communication session security level. For example, in the above-described example in which the communication session security level is either SECRET or TOP-SECRET and the combined security level is SECRET, TOP-SECRET, or TS/SCI, a combined security level of SECRET may be associated with a communication session security level of SECRET and a combined security level of either TOP-SECRET or TS/SCI may be associated with a communication session security level of SECRET. In certain embodiments, to facilitate the association of the determined combined security level with the appropriate communication session security level, B2BUA 116 may include a table (e.g., a communication session security level table) including each possible combined security level and the communication session security level with which it is associated.

Having determined a communication session security level associated with the requested communication session, B2BUA 116 may determine a communication session path for the requested communication session. In certain embodiments, B2BUA 116 may determine the communication session path for a requested communication session based on the determined security levels associated with the first and second endpoints, the communication session security level, and/or the domain (IP or TDM) of the first and second endpoints (as described below with regard to Table 1). Furthermore, the determined communication session path may include one or more elements of cross-connect 118 (described in further detail below) in order to ensure that media exchanged over the communication session path remains secure (e.g., either encrypted or physically separated from media being exchanged in a communication session having a differing communication session security level) at all points along the path.

Having determined a communication session path that ensures that exchanged media remains secure at all points along the path, B2BUA 116 may communicate the determined path to first and/or second endpoints such that the requested communication session may be established, as described in further detail below with regard to Table 1.

Adjudicator 104 of system 100 may include a cross-connect 118. Cross-connect 118 may facilitate the exchange of media between endpoints in system 100 during a communication session (established by B2BUA 116, as described above) while ensuring that the exchanged media remains secure (either through encryption or physical separation from media exchanged in communication sessions having differing communication session security levels, as described below).

Cross-connect 118 may include one or more media processing modules 126. In certain embodiments, cross-connect 118 includes a media processing module 126 corresponding to each possible communication session security level. For example, if there are two possible communication session security levels (SECRET and TOP-SECRET, as described above), cross-connect 118 may include two media processing modules (SECRET media processing module 128a and TOP-SECRET media processing module 128b).

The one or more media processing modules may each receive media from/communicate media to IP endpoints 102 via IP network 106 and receive media from/communicate media to TDM endpoints 108 via circuit network 110 as described in further detail below with regard to Table 1). For example, media processing modules 126 may receive media from (or communicate media to) IP endpoints 102 via media ports 124 using one or more media control protocols. In certain embodiments, the media control protocols include real-time transport protocol (RTP) (RFC 3550) with encryption based on the advanced encryption standard (AES) according to the secure real-time control protocol (SRTP)(RFC 3711). Furthermore, the RTP may use real-time control protocol (RTCP) for media setup between two endpoints. In secure applications, Datagram transport layer security (TLS) may be used for the transmission of RTCP signaling according to (RFC 4347).

Each media processing module 126 may include an encryption/decryption element 128. Encryption/decryption elements 128 of media processing modules 126 may decrypt media received from an IP endpoint 102 via IP network 106 such that the received media may be communicated to TDM endpoint 108 via circuit-based network 110, as described in further detail below. Additionally, encryption/decryption elements 128 of media processing modules 126 may encrypt media received from a TDM endpoint 108 via circuit-based network 110 such that the received media may be communicated to an IP endpoint 102 via IP network 106, as described in further detail below.

Each media processing module 126 may also include one or more processing modules 130, and one or more memory modules 132. Processing modules 130 may include one or more microprocessors, controllers, or any other suitable computing devices or resources and may work, either alone or with other components of system 100, to provide a portion or all of the functionality of system 100 described herein. Memory modules 132 may take the form of volatile or non-volatile memory including, without limitation, magnetic media, optical media, random access memory (RAM), read-only memory (ROM), removable media, or any other suitable memory component.

Cross-connect 118 may include TDM logic 134. TDM logic 134 may reformat media received from an IP endpoint 102 via packet-based IP network 106 into a format that may be communicated to a TDM endpoint 108 via circuit-based network 110, as described in further detail below.

Cross-connect 118 may include a TDM bus 136. TDM bus 136 may communicate the reformatted media received from the IP endpoint 102 to the TDM endpoint 108 via circuit-based network 110, as described in further detail below.

Additionally, TDM bus 136 may receive media from a TDM endpoint 108 via circuit-based network 110 and pass the received media to TDM logic 134. TDM logic 134 may reformat the received media such that the media can be encrypted by an encryption/decryption element 128 of an appropriate media processing module 126 and communicated to an IP endpoint 108 via IP network 106.

Table 1 and the description that follows describe example communication session scenarios (both within the IP domain and the mixed domain) and the communication session paths associated with the communication session scenarios. Although Table 1 describes particular endpoints having particular associated security levels, the present invention contemplates any suitable endpoints having any suitable associated security levels, according to particular needs.

TABLE 1
Example Communication Sessions

| | | 1st Endpoint (Initiator) | | | |
|---|---|---|---|---|---|
| | | SECRET | | SECRET | |
| | | IP | TS IP | TDM | TS TDM |
| 2nd | SECRET-IP | 1 | 2 | 3 | 3 |
| Endpoint | TS-IP | 2 | 1 | 3 | 4 |
| (Desti- | SECRET-TDM | 5 | 5 | 7 | 7 |
| nation) | TS-TDM | 5 | 6 | 7 | 7 |

### Example Scenario 1

In this example scenario, B2BUA 116 receives a request from a first endpoint (e.g., IP endpoint 102a) to communicate with a second (e.g., IP endpoint 102b). B2BUA 116 may determine a first security level associated with IP endpoint 102a (e.g., SECRET) and a second security level associated with the IP endpoint 102b (e.g., SECRET), as described above. Because the first and second security levels are the same (e.g., SECRET) and the first and second endpoints are of the same domain (i.e., both are IP endpoints), B2BUA 116 may determine that the appropriate communication session path between IP endpoint 102a and IP endpoint 102b is over IP network 106 (i.e., IP endpoint 102a and IP endpoint 102b may communicate directly over IP network 106). Additionally, B2BUA 116 may determine the appropriate communication session path without first determining a communications session security level.

B2BUA 116 may then provide the IP address of the destination (IP endpoint 102b) to the initiator (IP endpoint 102a) and IP endpoint 102a and IP endpoint 102b will complete the communication session (e.g., a SIP trapezoid call). In other words, IP endpoint 102a and IP endpoint 102b may exchange media without additional intervention from adjudicator 102.

The confidentiality of the exchanged media is maintained at all points along the communication session path through encryption, as media (e.g., packets) communicated from a sending endpoint is encrypted (e.g., by an endpoint encryption/decryption element 112, described above) prior to passing over IP network 106 and is decrypted by the receiving endpoint (e.g., by an endpoint encryption/decryption element 112, described above). IP endpoint 102a and IP endpoint 102b may then inform adjudicator 104 when the communication session is cleared so call history can be maintained.

### Example Scenario 2

In this example scenario, B2BUA 116 receives a request from a first endpoint (e.g., IP endpoint 102a) to communicate with a second endpoint (e.g., IP endpoint 102b). B2BUA 116 may determine a first security level associated with the IP endpoint 102a (e.g., SECRET) and a second security level associated with the IP endpoint 102b (e.g., TOP-SECRET), as described above. B2BUA 116 may determine a combined security level (e.g., SECRET) based on the first security level (e.g., SECRET) and the second security level (e.g., TOP-SECRET). Furthermore, based on the determined combined security level, B2BUA 116 may determine a communication session security level of SECRET.

Having determined the communication session security level (SECRET), B2BUA 116 may determine the appropriate communication session path between IP endpoint 102a and IP endpoint 102b. Because IP endpoint 102a and IP endpoint 102b are of similar domain (IP) but dissimilar security level, there is potential for variation in the communication session security level. As a result of this potential, the appropriate communication session path may include a media processing module 126 of adjudicator 104 corresponding to the determined communication session security level (e.g., SECRET media processing module 126a).

B2BUA 116 may provide both endpoints with the address of the SECRET media port 124a of SECRET media processing module 126a so both endpoints may connect to SECRET media port 124a and SECRET media processing module 126a can control the media session. In other words, rather than IP endpoint 102a and IP endpoint 102b exchanging media directly with one another (as in scenario 1, described above), IP endpoint 102a will communicate media (e.g. encrypted packets) to SECRET media processing module 126a, which will direct the packets to endpoint 102b via IP network 106 (i.e., SECRET media processing module 126a will “capture” the communication session).

As in example scenario 1, the confidentiality of the exchanged media is maintained at all points along the communication session path through encryption, as media (e.g., packets) communicated from a sending endpoint is encrypted (e.g., by an endpoint encryption/decryption element 112, described above) prior to passing over IP network 106 and is decrypted by the receiving endpoint (e.g., by an endpoint encryption/decryption element 112, described above). IP endpoint 102a and IP endpoint 102b may then inform adjudicator 104 when the communication session is cleared so call history can be maintained.

### Example Scenario 3

In this example scenario, B2BUA 116 receives a request from a first endpoint (e.g., TDM endpoint 108a) to communicate with a second endpoint (e.g., IP endpoint 102a). B2BUA 116 may determine a first security level associated with the TDM endpoint 108a (e.g., SECRET or TOP-SECRET) and a second security level associated with the IP endpoint 102a (e.g., SECRET or TOP-SECRET), as described above. Assuming that either TDM endpoint 108a or IP endpoint 102a has an associated security level of SECRET (i.e., TDM endpoint 108a and IP endpoint 102a do not both have an associated security level of TOP-SECRET), B2BUA 116 may determine a combined security level of SECRET. Furthermore, based on the determined combined security level, B2BUA 116 may determine a communication session security level of SECRET.

Having determined the communication session security level (SECRET), B2BUA 116 may determine the appropriate communication session path between TDM endpoint 108a and IP endpoint 102a. Because TDM endpoint 108a (initiator) and IP endpoint 102a (destination) are of dissimilar domain, the appropriate communication session path may include the media processing module 126 of adjudicator 104 that corresponds to the determined communication session security level (e.g., SECRET media processing module 126a). The media processing module providing a secure link between circuit-based network 110 and IP network 106.

B2BUA 116 may signal IP endpoint 102a (destination) of the requested communication session, and upon answer, the communication session may be established via SECRET processing module 126a.

For media passing from TDM endpoint 108a to IP endpoint 102a, TDM bus 136 may receive the media from TDM endpoint 108a and pass the received media to TDM logic 134. The received media is secure as it passes from TDM endpoint 108a to TDM logic 134a because, due to the time-sliced and synchronized nature of TDM, the media is physically separated from media being exchanged in other communication sessions of possibly differing communication session security levels. TDM logic 134 may reformat the received media such that the media may be communicated to IP endpoint 102a via packet-based IP network 106.

Once reformatted, security with respect to the received media is no longer achieved through the physical separation resulting from the nature of TDM transmission (physical separation is not inherent in packet based transmission). However, the reformatted media is passed to SECRET media processing module 126a, which handles only media exchanged in communication sessions having a communication security level of SECRET. Thus, physical separation from media exchanged in communication sessions having differing communication session security levels is maintained. Encryption/decryption element 128a of media processing module 126a then encrypts the received media and communicates it to IP endpoint 102a via IP network 106, the media remaining secure as it traverses network 108 due to the encryption. IP endpoint 102a then receives the encrypted media and decrypts the media.

Thus, media communicated from TDM endpoint 108a to IP endpoint 102a remains secure (either encrypted or physically separated from media exchanged during communication sessions having differing communication session security levels) at all points along the communication path. Similarly, media communicated from IP endpoint 102a to TDM endpoint 108a remains secure (either encrypted or physically separated from media exchanged during communication sessions having differing communication session security levels) at all points along the communication path as the above described flow is performed in the reverse.

Once the communication session is complete, the adjudicator 104 will complete the communication session by making the TDM internal connection.

### Example Scenario 4

In this example scenario, B2BUA 116 receives a request from a first endpoint (e.g., TDM endpoint 108a) to communicate with a second endpoint (e.g., IP endpoint 102a). B2BUA 116 may determine a first security level associated with the TDM endpoint 108a (e.g., TOP-SECRET) and a second security level associated with the IP endpoint 102a (e.g., TOP-SECRET), as described above. Because TDM endpoint 108a and IP endpoint 102a both have an associated security level of TOP-SECRET, B2BUA 116 may determine a combined security level of TOP-SECRET. Furthermore, based on the determined combined security level, B2BUA 116 may determine a communication session security level of TOP-SECRET.

Having determined the communication session security level (e.g., TOP-SECRET), B2BUA 116 may determine the appropriate communication session path between TDM endpoint 108a and IP endpoint 102a. Because the first TDM endpoint 108a and IP endpoint 102a are of dissimilar domain, the appropriate communication session path may include the media processing module 126 of adjudicator 104 that corresponds to the determined communication session security level (e.g., TOP-SECRET media processing module 126b). The media processing module may provide a secure link between circuit-based network 110 and IP network 106. The communication session may then be established and media exchanged in a substantially similar manner as that discussed above in scenario 3.

### Example Scenario 5

In this example scenario, B2BUA 116 receives a request from a first endpoint (e.g., IP endpoint 102a) to communicate with a second endpoint (e.g., TDM endpoint 102a). B2BUA 116 may determine a first security level associated with IP endpoint 102a (e.g., SECRET or TOP-SECRET) and a second security level associated with TDM endpoint 108a (e.g., SECRET or TOP-SECRET), as described above. Assuming that either IP endpoint 102a or TDM endpoint 108a has an associated security level of SECRET (i.e., IP endpoint 102a and TDM endpoint 108a do not both have an associated security level of TOP-SECRET), B2BUA 116 may determine a combined security level of SECRET. Furthermore, based on the determined combined security level, B2BUA 116 may determine a communication session security level of SECRET.

Having determined the communication session security level (SECRET), B2BUA 116 may determine the appropriate communication session path between the IP endpoint 102a and TDM endpoint 108a. As described above with regard to example scenario 3, because IP endpoint 102a (initiator) and TDM endpoint 108a (destination) are of dissimilar domain, the appropriate communication session path may include the media processing module 126 of adjudicator 104 that corresponds to the determined communication session security level (e.g., SECRET media processing module 126a).

The requested communication session may then be established over the determined communication session path (including SECRET media processing module 126a) and media may be exchanged between IP endpoint 102a and TDM endpoint 108a, as discussed above with regard to example scenario 3. Additionally, any security level adjudication in the TDM domain (if required) with respect to TDM endpoint 108a (destination) will be performed transparent to IP endpoint 102a (initiator).

### Example Scenario 6

In this example scenario, B2BUA 116 receives a request from a first endpoint (e.g., IP endpoint 102a) to communicate with a second endpoint (e.g., TDM endpoint 102a). B2BUA 116 may determine a first security level associated with IP endpoint 102a (e.g., TOP-SECRET) and a second security level associated with TDM endpoint 108a (e.g., TOP-SECRET), as described above. Because both of IP endpoint 102a and TDM endpoint 108a have an associated security level of TOP-SECRET, B2BUA 116 may determine a combined security level of TOP-SECRET. Furthermore, based on the determined combined security level, B2BUA 116 may determine a communication session security level of TOP-SECRET.

Having determined the communication session security level (TOP-SECRET), B2BUA 116 may determine the appropriate communication session path between the IP endpoint 102a and TDM endpoint 108a. As described above with regard to example scenario 3, because IP endpoint 102a (initiator) and TDM endpoint 108a (destination) are of dissimilar domain, the appropriate communication session path may include the media processing module 126 of adjudicator 104 that corresponds to the determined communication session security level (e.g., TOP-SECRET media processing module 126b).

The requested communication session may then be established over the determined communication session path (including TOP-SECRET media processing module 126b), and media may be exchanged between IP endpoint 102a and TDM endpoint 108a, as discussed above with regard to example scenario 3. Additionally, any security level adjudication in the TDM domain (if required) with respect to the second TDM endpoint 108 will be performed transparent to the first IP endpoint 102. Additionally, IP endpoint 102a (initiator) will be informed of any security level adjudication in the TDM domain (if required) with respect to TDM endpoint 108a (e.g., to a lower security access level) so that the change can be displayed on the instrument (IP endpoint 102a).

### Example Scenario 7

In this example scenario, adjudicator 104 may establish a communication session may be established between TDM endpoints 109 using any suitable method for establishing TDM communications sessions. Furthermore, as described above, adjudicator 104 may maintain security with respect to media exchanged between TDM endpoints through separation in time.

Although a particular implementation of system 100 is illustrated and primarily described, the present invention contemplates any suitable implementation of system 100 according to particular needs. Although a particular number of components of system 100 have been illustrated and primarily described above, the present invention contemplates system 100 including any suitable number of such components. Furthermore, the various components of system 100 described above may be local or remote from one another. Additionally, the components of system 100 may be implemented in any suitable combination of hardware, firmware, and software.

In operation of an example embodiment of system 100, B2BUA 116 of adjudicator 104 may receive, from a first endpoint (IP endpoint 102 or TDM endpoint 108), a request to establish a communication session with a second endpoint (IP endpoint 102 or TDM endpoint 108).

B2BUA 116 may determine a first security level associated with the first endpoint and a second security level associated with the second endpoint. In certain embodiments, B2BUA 116 may determined the first and second security levels based on the unique addresses associated with the first and second endpoints and security level table 122. In certain other embodiments, the first security level and/or the second security level may be communicated to B2BUA 116 by the first endpoint along with the request to establish a communication session, as described above.

B2BUA 116 may determine, based on the first security level associated with the first endpoint and the second security level associated with the second endpoint, a communication session security level for the requested communication session. The determined communication session security level may be selected from a group of communication session security levels having corresponding media processing modules 126 in cross-connect 118. In certain embodiments, B2BUA 116 determines the communication session security level by determining a combined security level based on the first security level associated with the first endpoint and the second security level associated with the second endpoint and associating the combined security level with a communication session security level. The possible combined security levels may include any security level that may be associated with an endpoint (e.g., SECRET, TOP-SECRET, or TS/SCI) and may correspond to the highest possible security level at which both endpoints are authorized to communicate. Having determined a combined security level, B2BUA 116 may associate the combined security level with a communication session security level. Each possible combined security level may be associated with a particular communication session security level.

B2BUA 116 may determine a communication session path for the requested communication session. In certain embodiments, B2BUA 116 may determine the communication session path for a requested communication session based on the determined security levels associated with the first and second endpoints, the communication session security level, and/or the domain (IP or TDM) of the first and second endpoints (as described above with regard to Table 1). Furthermore, the determined communication session path may include a media processing module 126 of cross-connect 118 in order to ensure that media exchanged over the communication session path remains secure (e.g., either encrypted or physically separated from media being exchanged in a communication session having a differing communication session security level) at all points along the path.

B2BUA 116 may then establish the requested communication session. For example, B2BUA 116 may communicate the determined path to first and/or second endpoints. Once the communication session has been established, the first and second endpoints may exchange media, as described above with regard to Table 1.

Particular embodiments of the present invention may provide one or more technical advantages. In certain applications, particular organizations may utilize multi-level secure (MLS) communication systems that are capable of facilitating multiple, simultaneous communications sessions for exchanging media having differing sensitivities (i.e., security levels) while maintaining a certain degree of security with respect to the exchanged media. The degree of security maintained with respect to the exchanged media may vary depending on the particular implementation of the MLS communication system. For example, the United States government may utilize a MLS communication system for exchanging media classified as SECRET, TOP-SECRET (TS), or TOP-SECRET/SENSITIVE COMPARTMENTED INFORMATION (TS/SCI). Furthermore, the Director of Central Intelligence Directive (DCID) 6/3 specification states that an MLS communication system that processes TS/SCI must separate media of differing security levels either through encryption or physical separation in order to limit access to media to only those users having appropriate security authorizations.

One approach to providing an MLS communication system includes a circuit-based, time-division multiplexed (TDM) architecture. A circuit-based TDM architecture may meet the requirements of the DCID 6/3 specification by performing “separation in time.” In separation in time, all circuits are time-sliced, synchronized, and constantly monitored such that media of differing security levels is physically separated at all points within the architecture. Communication systems, however, are increasingly being implemented using packet-based architectures (e.g., Internet Protocol (IP) architectures) rather than circuit-based architectures (e.g., TDM architectures). Furthermore, mechanisms used to maintain security in the TDM domain (e.g., separation in time) cannot be applied in the IP domain. Thus, a need exists for a MLS communication network operable to facilitate communication sessions in the IP domain while maintaining a degree of security with respect to exchanged media, such as the degree of security required by the DCID 6/3 specification.

In certain embodiments, the MLS communication system 100 facilitates communication sessions in the IP domain (e.g., by facilitating communication sessions between endpoints via an IP network) as well as in the mixed domain (e.g., communications sessions between an endpoint located in the IP domain and an endpoint in the TDM domain). Additionally, MLS communication system 100 may maintain security with respect to media exchanged in the facilitated communication sessions by ensuring that the media exchanged is either encrypted or physically separated from media of differing security levels at all points within the system. Thus, certain embodiments of the present invention may increase communication capabilities, such as in applications requiring multi-level security (e.g., applications required to meet the requirements of the DCID 6/3 specification).

FIG. 2 illustrates an example method 200 for establishing a communication session in an example multi-level secure communication system 100, according to certain embodiments of the present invention. The method begins at step 202. At step 204, B2BUA 116 of adjudicator 104 receives from a first endpoint (IP endpoint 102 or TDM endpoint 108) a request to establish a communication session with a second endpoint (IP endpoint 102 or TDM endpoint 108).

At step 206, B2BUA 116 determines a first security level associated with the first endpoint and a second security level associated with the second endpoint. In certain embodiments, B2BUA 116 may determined the first and second security levels based on the unique addresses associated with the first and second endpoints and security level table 122, as described above. In certain other embodiments, the first security level and/or the second security level may be communicated to B2BUA 116 by the first endpoint along with the request to establish a communication session, as described above.

At step 208, B2BUA determines, based on the first security level associated with the first endpoint and the second security level associated with the second endpoint, a communication session security level for the requested communication session. The determined communication session security level may be selected from a group of communication session security levels having corresponding media processing modules 126 in cross-connect 118.

In certain embodiments, B2BUA 116 determines the communication session security level by determining a combined security level based on the first security level associated with the first endpoint and the second security level associated with the second endpoint and associating the combined security level with a communication session security level. The possible combined security levels may include any security level that may be associated with an endpoint (e.g., SECRET, TOP-SECRET, or TS/SCI) and may correspond to the highest possible security level at which both endpoints are authorized to communicate.

Having determined a combined security level, B2BUA 116 may associate the combined security level with a communication session security level. Each possible combined security level may be associated with a particular communication session security level. For example, in the above-described example in which the communication session security level is either SECRET or TOP-SECRET and the combined security level is SECRET, TOP-SECRET, or TS/SCI, a combined security level of SECRET may be associated with a communication session security level of SECRET and a combined security level of either TOP-SECRET or TS/SCI may be associated with a communication session security level of SECRET.

At step 210, B2BUA 116 may determine a communication session path for the requested communication session. In certain embodiments, B2BUA 116 may determine the communication session path for a requested communication session based on the determined security levels associated with the first and second endpoints, the communication session security level, and/or the domain (IP or TDM) of the first and second endpoints (as described above with regard to Table 1). Furthermore, the determined a communication session path may include a media processing module 126 of cross-connect 118 in order to ensure that media exchanged over the communication session path remains secure (e.g., either encrypted or physically separated from media being exchanged in a communication session having a differing communication session security level) at all points along the path.

At step 212, B2BUA 116 may establish the requested communication session. For example, B2BUA 116 may communicate the determined path to first and/or second endpoints.

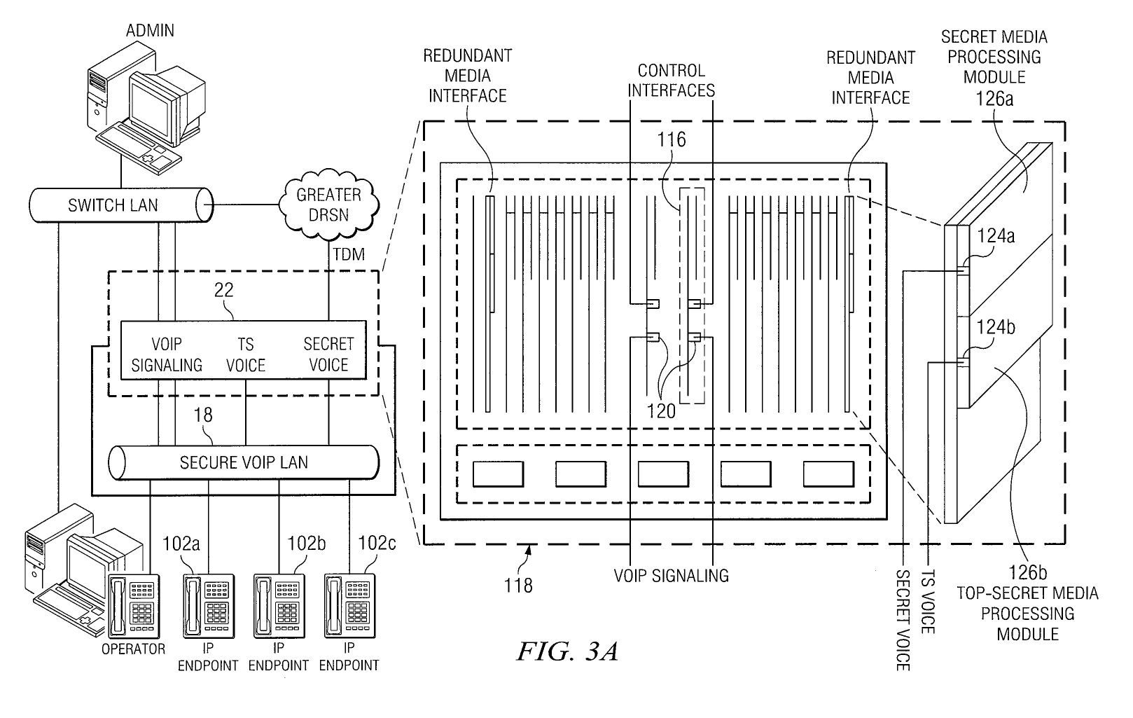

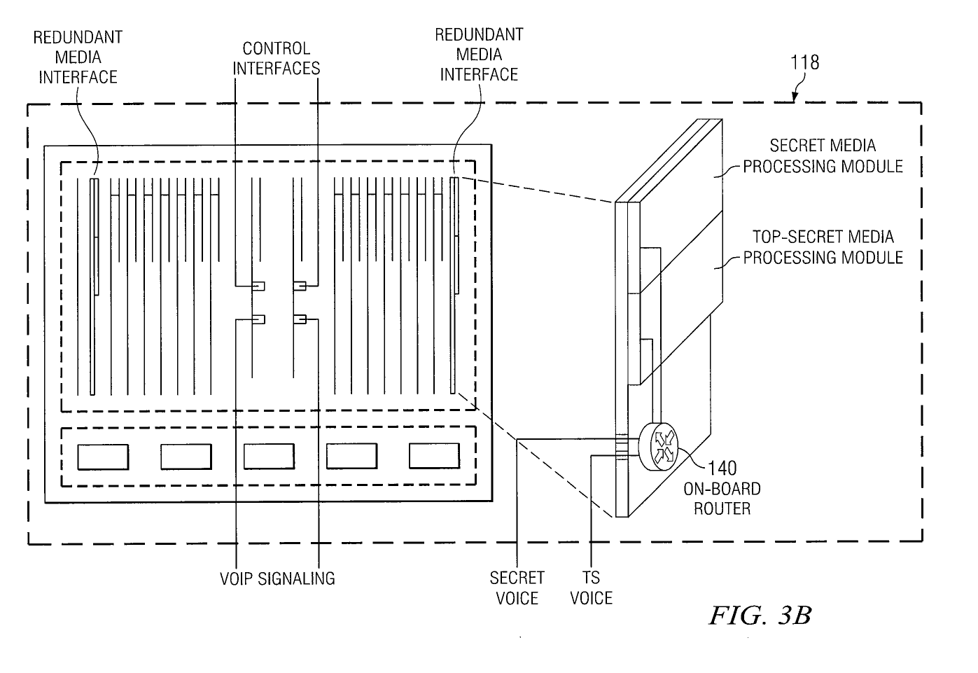

FIGS. 3A-3B illustrate example hardware configurations of cross-connect 118 of adjudicator 104 in an example multi-level secure communication system 100 according to certain embodiments of the present invention.

More particularly, FIG. 3A illustrates a particular hardware configuration of cross-connect 118 in which media streams are brought into adjudicator 104 via separate media ports 124, each media port 124 associated with a particular media processing module 126. Furthermore, redundancy with respect to media is achieved by providing a minimum of two media processing modules associated with each possible communication session security level (e.g., SECRET or TOP-SECRET), each media processing module having an associated media port 124 (i.e., SECRET media port 124a of SECRET media processing module 126a and TOP-SECRET media port 124b of TOP-SECRET media processing module 126b). Additionally, redundancy is provided with respect to control signaling by providing a minimum of two B2BUAs 116, each B2BUA 116 having an associated control port 120.

FIG. 3B illustrates alternative hardware configuration of cross-connect 118 in which a router 140 directs media received via IP network 106 (e.g., IP packets) to the appropriate media processing module 126 for delivery to an appropriate destination via either IP network 106 or circuit network 110, as described above.

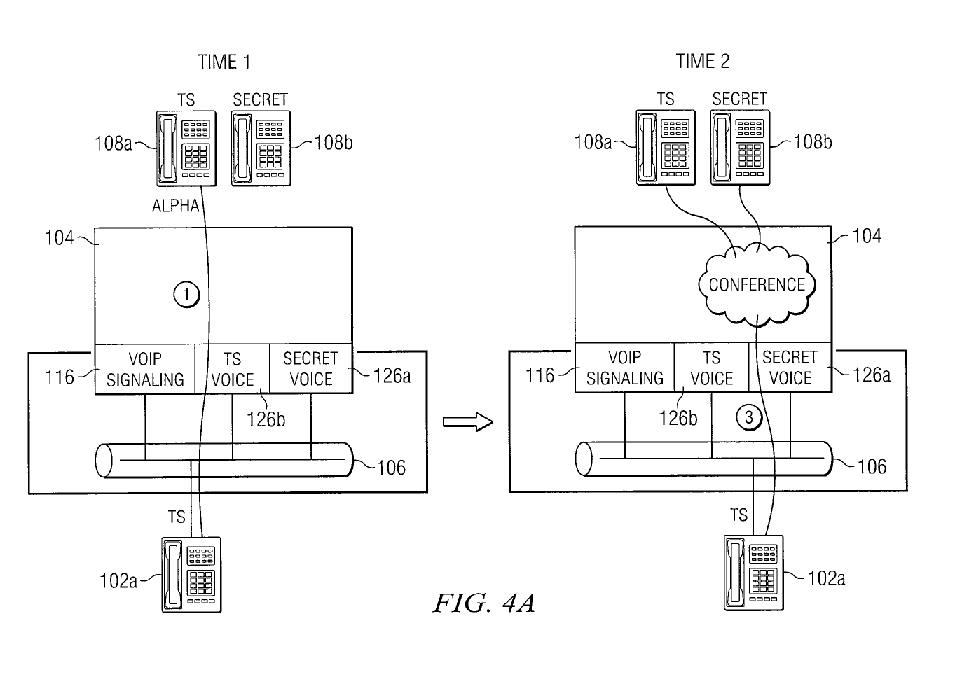

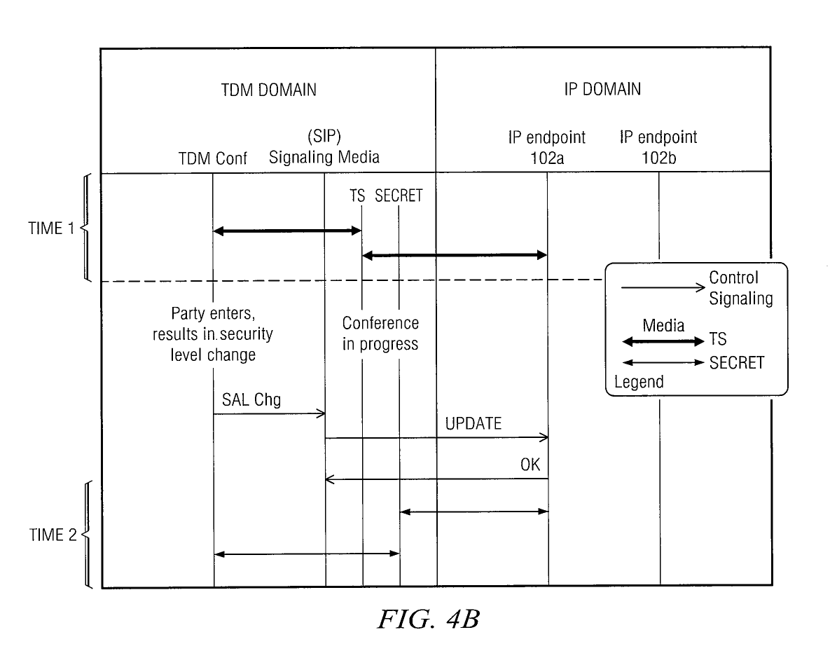

FIGS. 4A-4B illustrate a conference call situation and associated example call flow resulting in a change in communication session security level in an example multi-level secure communication system 100, according to certain embodiments of the present invention. Although the example call flow for is illustrated and primarily described as being performed using a particular session control protocol (SIP), the present invention contemplates the call flow being performed using any suitable protocol (e.g., H.323 protocol or CISCO SCCP), according to particular needs.

As illustrated in FIG. 4A, a communication session may be established (as described above) between IP endpoint 102a (having an associated TOP-SECRET security level) and TDM endpoint 108a (having an associated TOP-SECRET security level) over communication session including TOP-SECRET media processing module 126b.

If TDM endpoint 108b (having an associated SECRET security level) enters the communication session (e.g., a conference call is established), the TDM conference (including TDM endpoints 108a and 108b) may notify adjudicator 104 (e.g., B2BUA 116 of adjudicator 104) that TDM endpoint 108b (having an associated SECRET security level) has entered the conference. Adjudicator 104 may then determine a new communication session security level based on the security levels associated with IP endpoint 102a (TOP-SECRET), TDM endpoint 108a (TOP-SECRET), and TDM endpoint 108b (SECRET). Based on the determined new communication session security level (SECRET, determined as described above), adjudicator 104 may determine a new communication session path including a media processing module 126 corresponding to the new communication session security level (SECRET media processing module 126a).

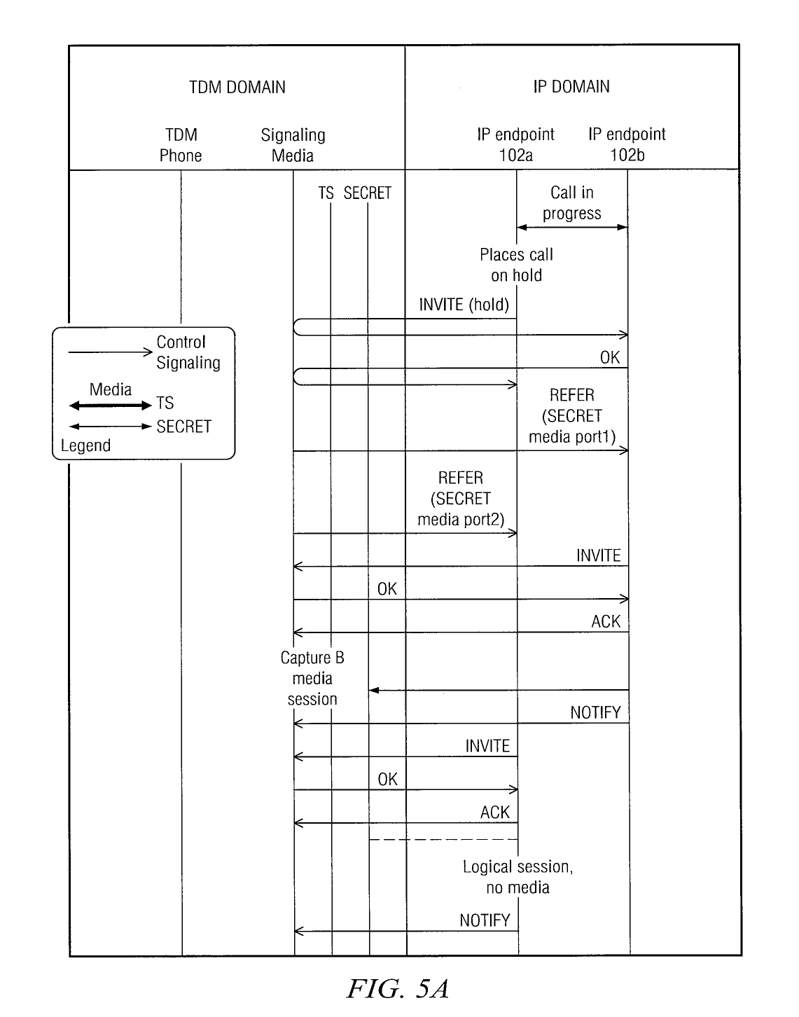

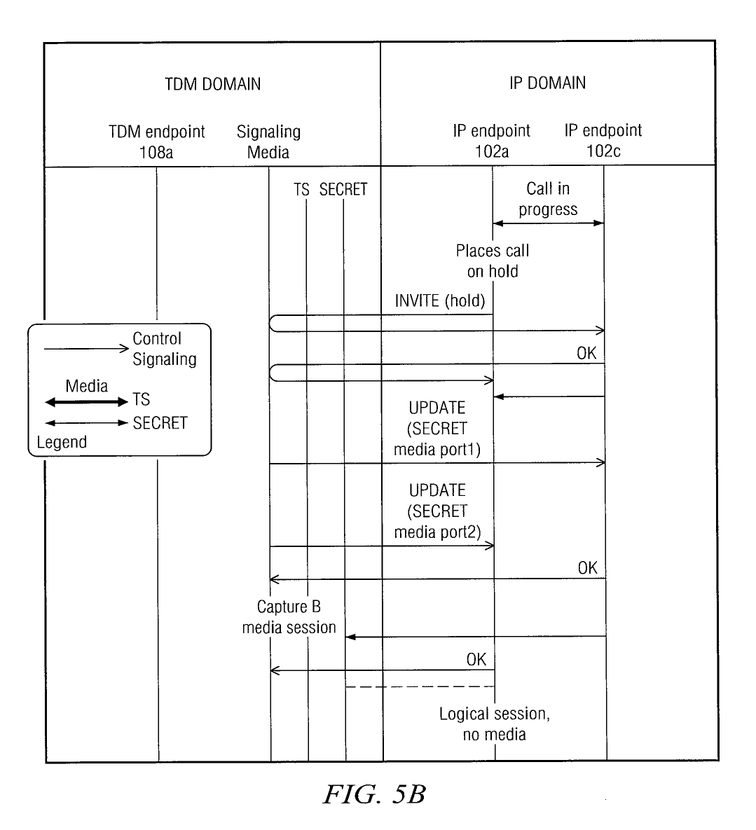

FIGS. 5A-5B illustrate example call flows for securely handling a call hold operation in an example multi-level secure communication system 100, according to certain embodiments of the present invention. The illustrated call flows relate to a communication session established between IP endpoint 102a (having an associated TOP-SECRET security level) and IP endpoint 102b (having an associated TOP-SECRET security level), IP endpoint 102a and IP endpoint 102b communicating directly with one another over IP network 106 (because they are of the same domain and have the same security level, as described above). Although the example call flows for securely handling a call hold operation are illustrated and primarily described as being performed using a particular session control protocol (SIP), the present invention contemplates the call flows being performed using any suitable protocol (e.g., H.323 protocol or CISCO SCCP), according to particular needs.

IP endpoint 102a may communicate with adjudicator 104 (e.g., B2BUA 116 of adjudicator 104) to place IP endpoint 102b on hold during the communication session. In response to the hold request, adjudicator 104 may determine that the media transferred by IP endpoint 102b should be captured by TOP-SECRET media processing module 126b during the time that IP endpoint 102b is on hold (i.e., IP endpoint 102b should be connected to TOP-SECRET media processing module 126b rather than directly to IP endpoint 102a). Thus, security will be maintained with respect to media being transferred by IP endpoint 102b. For example, if during the time that IP endpoint 102b is on hold IP endpoint 102a enters a communication session with IP endpoint 102c (having an associated SECRET security level), TOP-SECRET media transferred by IP endpoint 102b will not be stored at IP endpoint 102a along with SECRET media received by IP endpoint 102a from IP endpoint 102c (as the media transferred by IP endpoint 102b will be captured by TOP-SECRET media processing module 126b).

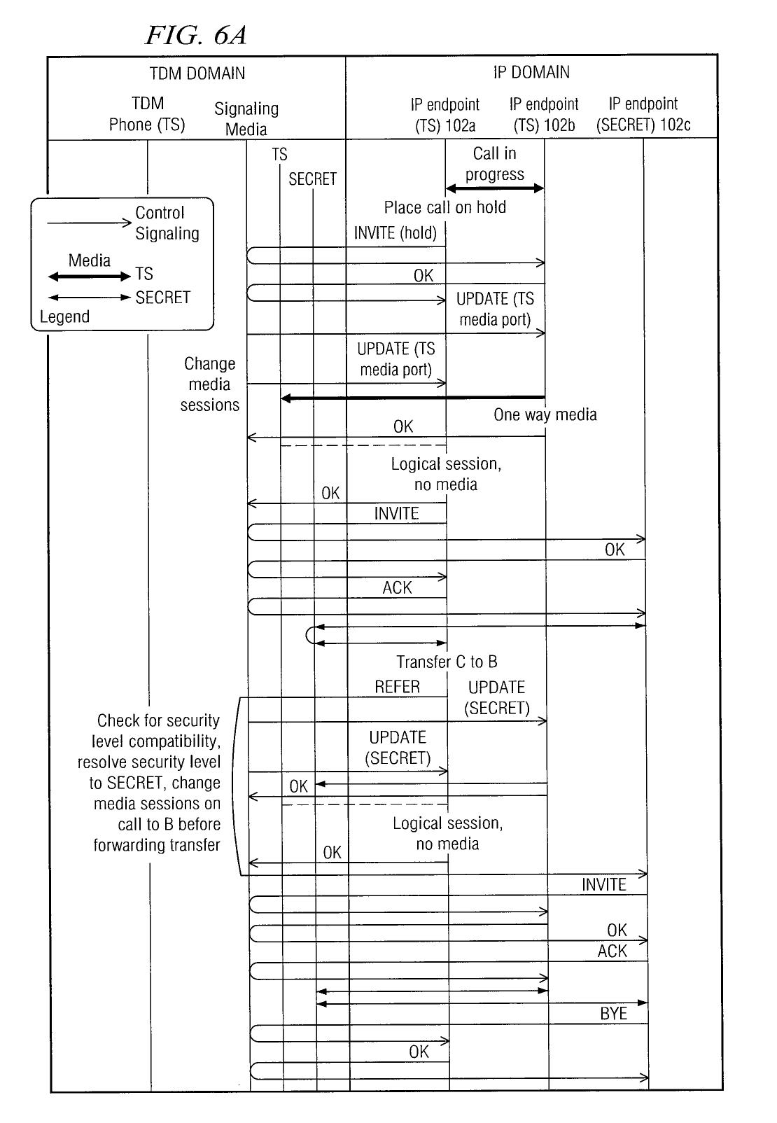

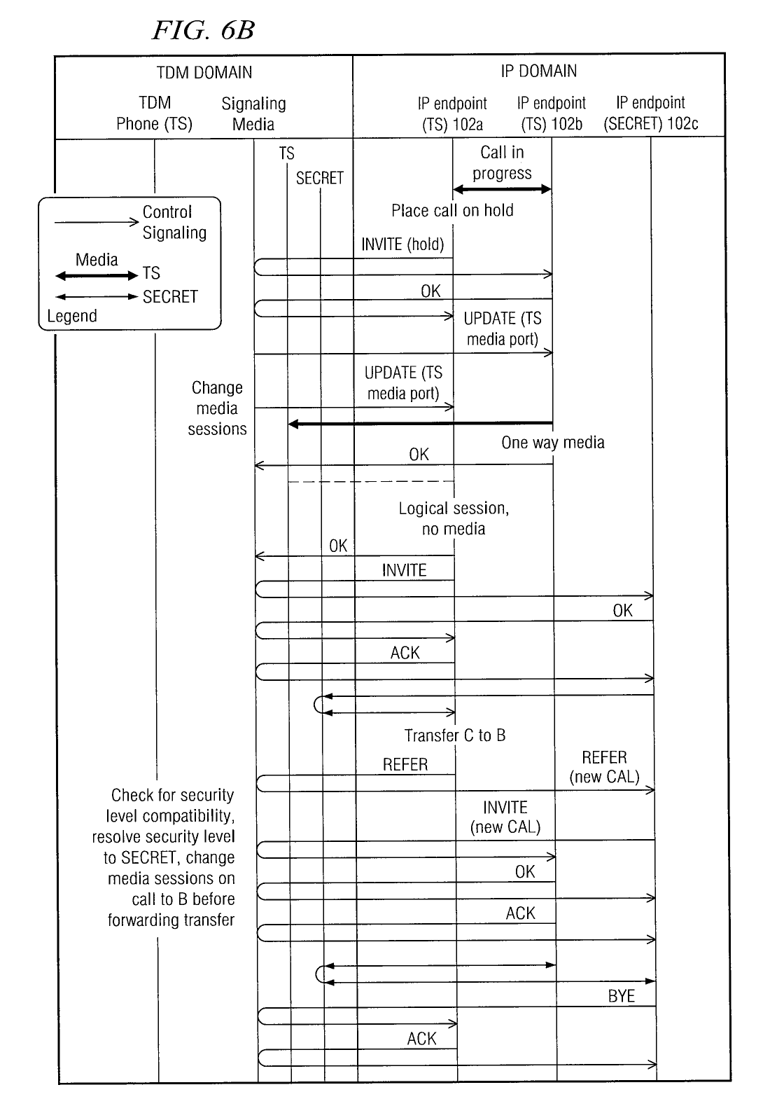

FIGS. 6A-6B illustrate example call flows for securely handling a call transfer operation in an example multi-level secure communication system 100, according to certain embodiments of the present invention. The illustrated call flows relate to a communication session established between IP endpoint 102a (having an associated TOP-SECRET security level) and IP endpoint 102b (having an associated TOP-SECRET security level), IP endpoint 102a and IP endpoint 102b communicating directly with one another over IP network 106 (because they are of the same domain and have the same security level, as described above). Although the example call flows for securely handling a call transfer operation are illustrated and primarily described as being performed using a particular session control protocol (SIP), the present invention contemplates the call flows being performed using any suitable protocol (e.g., H.323 protocol or CISCO SCCP), according to particular needs.

IP endpoint 102a may communicate with adjudicator 104 (e.g., B2BUA 116 of adjudicator 104) to transfer the communication session (call) with IP endpoint 102b to IP endpoint 102c (having an associated SECRET security level). In response to the transfer request, adjudicator 104 may determine that media cannot be transferred directly between IP endpoint 102b and IP endpoint 102c as IP endpoint 102b and IP endpoint 102c are of dissimilar security level. Instead, adjudicator 104 may determine a communication session security level base on the security level associated with IP endpoint 102b (TOP-SECRET) and the security level associated with IP endpoint 102c (SECRET), as described above. Based on the determined communication session security level (SECRET), adjudicator 104 may determine a communication session path including SECRET media processing module 126a, as described above. The communication session may then be established between IP endpoint 102b and IP endpoint 102c over the determined communication session path including SECRET media processing module 126a.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for establishing a communication session, comprising:
receiving, from a first endpoint having an associated first security level and operable to communicate via an IP network, a request to establish a communication session with a second endpoint having an associated second security level, the first security level being different than the second security level;
determining, based on the first security level associated with the first endpoint and the second security level associated with the second endpoint, a communication session security level;
determining a communication session path for the requested communication session, the communication session path comprising a media processing module corresponding to the determined communication session security level; and
establishing the requested communication session with the second endpoint over the determined communication session path.

2. The method of claim 1, wherein the second endpoint is operable to communicate via the IP network, the method comprising:
receiving, at the media processing module, an IP data packet from the first endpoint via the IP network; and
communicating the received first IP data packet to the second endpoint via the IP network.

3. The method of claim 2, wherein the IP network comprises a local area network (LAN).

4. The method of claim 2, wherein the IP data packet received from the first endpoint via the IP network comprises encrypted data.

5. The method of claim 4, wherein the encrypted data of the IP data packet received from the first endpoint is encrypted by the first endpoint using the Advanced Encryption Standard (AES).

6. The method of claim 1, wherein the second endpoint is operable to communicate via a circuit network, the method comprising:
receiving, at the determined media processing module, an IP data packet from the first endpoint via the IP network;
reformatting the received IP data packet such that it can be communicated via the circuit network; and
communicating the reformatted IP data packet to the second endpoint via the circuit network.

7. The method of claim 6, wherein circuit network comprises a TDM-based network.

8. The method of claim 6, wherein the IP data packet received from the first endpoint via the IP network comprises encrypted data, the method further comprising decrypting the received IP data packet.

9. The method of claim 8, wherein the encrypted data of the IP data packet received from the first endpoint device is encrypted by the first endpoint using the Advanced Encryption Standard (AES).

10. A system for establishing a communication session, the system comprising one or more processing units operable to:
receive, from a first endpoint having an associated first security level and operable to communicate via an IP network, a request to establish a communication session with a second endpoint having an associated second security level, the first security level being different than the second security level;
determine, based on the first security level associated with the first endpoint and the second security level associated with the second endpoint, a communication session security level;
determine a communication session path for the requested communication session, the communication session path comprising a media processing module corresponding to the determined communication session security level; and
establish the requested communication session with the second endpoint over the determined communication session path.

11. The system of claim 10, wherein the second endpoint is operable to communicate via the IP network, the one or more processing units operable to:
receiving, at the media processing module, an IP data packet from the first endpoint via the IP network; and
communicating the received first IP data packet to the second endpoint via the IP network.

12. The system of claim 11, wherein the IP network comprises a local area network (LAN).

13. The system of claim 11, wherein the IP data packet received from the first endpoint via the IP network comprises encrypted data.

14. The system of claim 13, wherein the encrypted data of the IP data packet received from the first endpoint is encrypted by the first endpoint using the Advanced Encryption Standard (AES).

15. The system of claim 11, wherein the second endpoint is operable to communicate via a circuit network, the one or more processing units operable to:
receive, at the determined media processing module, an IP data packet from the first endpoint via the IP network;
reformat the received IP data packet such that it can be communicated via the circuit network; and
communicate the reformatted IP data packet to the second endpoint via the circuit network.

16. The system of claim 15, wherein circuit network comprises a TDM-based network.

17. The system of claim 15, wherein the IP data packet received from the first endpoint via the IP network comprises encrypted data, the method further comprising decrypting the received IP data packet.

18. The system of claim 17, wherein the encrypted data of the IP data packet received from the first endpoint device is encrypted by the first endpoint using the Advanced Encryption Standard (AES).

19. A method for establishing a communication session, comprising:
communicating, from a first endpoint having a first security level via an IP network, a request to establish a communication session with a second endpoint having an associated second security level, the first security level being different than the second security level;
receiving a communication session path for the requested communication session, the communication session path comprising a media processing module corresponding to a communication session security level determined based on the first security level associated with the first endpoint and the second security level associated with the second endpoint; and
establishing the requested communication session with the second endpoint over the determined communication session path.

20. The method of claim 19, comprising:
encrypting an IP data packet using the Advanced Encryption Standard (AES); and
communicating the encrypted IP data packet to the media processing module of the determined communication session path via the IP network.
